(19) United States
(12) Patent Application Publication
(10) Pub. No.: US 2017/0361746 A1
(43) Pub. Date: Dec. 21, 2017

(54) ADJUSTABLE SEAT ASSEMBLY AND VEHICLE ASSEMBLY

(71) Applicants: Winsen C. Zouzal, Detroit, MI (US); Lear Corporation, Southfield, MI (US)

(72) Inventors: Winsen C. ZOUZAL, Detroit, MI (US); Gerald PATRICK, Shelby Township, MI (US)

(21) Appl. No.: 15/182,984

(22) Filed: Jun. 15, 2016

(51) Int. Cl. B60N 2/64; B60N 2/48; B60R 1/00; B60R 22/26; B60R 22/20; B60K 26/02; B60R 1/04; B60T 7/06; B62D 1/10

(52) U.S. Cl. CPC B60N 2/643; B60R 1/04; B60N 2/4805; B60R 1/001; B60T 7/06; B60R 22/26; B60R 22/20; B60K 26/02; B60R 1/006; B60R 2300/205; B60K 2026/026; B62D 1/10

(57) ABSTRACT

A seat assembly is provided with a seat back, and first and second actuators oriented in first and second regions of the seat back. A safety restraint is connected to the seat back. A controller is programmed to operate the first and second actuators to adjust the first and second regions of the seat back. The controller may adjust the safety restraint in response to the adjustment of the actuators to coordinate the adjustment of the safety restraint with the sequential posture alignment. The controller may also adjust a vehicle vision device concurrently with the actuators to coordinate the adjustment of the vehicle vision device with the sequential posture alignment. The controller may also adjust a vehicle drive control manual input device concurrently with the adjustment of the actuators to coordinate the adjustment of the vehicle drive control manual input device with the sequential posture alignment.

### TECHNICAL FIELD

Various embodiments relate to adjustable seat assemblies and vehicle assemblies with adjustable seat assemblies and adjustable interior components.

### BACKGROUND

An adjustable seat assembly is illustrated and described in U.S. Pat. No. 5,758,924, which issued on Jun. 2, 1998 to Lear Corporation.

### SUMMARY

According to at least one embodiment, a seat assembly is provided with a seat back. A first actuator is oriented in a first region of the seat back. A second actuator is oriented in a second region of the seat back. A safety restraint is connected to the seat back. A third actuator is connected to the safety restraint. A controller is in electrical communication with the first and second actuators. The controller is programmed to operate the first actuator to adjust the first region of the seat back. The second actuator is operated to adjust the second region after initiating adjustment of the first actuator. The third actuator is operated to adjust the safety restraint in response to the adjustment of at least one of the first actuator and the second actuator to coordinate the adjustment of the safety restraint with the sequential posture alignment.

According to at least another embodiment, a seat assembly is provided with a seat back. A first actuator is oriented in a first region of the seat back. A second actuator is oriented in a second region of the seat back. A controller is in electrical communication with the first and second actuators. The controller is programmed to operate the first actuator to adjust the first region of the seat back. The second actuator is operated to adjust the second region after initiating adjustment of the first actuator. An output signal indicative of adjustment of a vehicle vision device is transmitted in response to the adjustment of at least one of the first actuator and the second actuator to coordinate the adjustment of the vehicle vision device with the sequential posture alignment.

According to at least another embodiment, a vehicle assembly is provided with a seat assembly with a seat back. A first actuator is oriented in a first region of the seat back. A second actuator is oriented in a second region of the seat back. A controller is in electrical communication with the first and second actuators. The controller is programmed to operate the first actuator to adjust the first region of the seat back. The second actuator is operated to adjust the second region after initiating adjustment of the first actuator. An output signal indicative of adjustment of a vehicle vision device is transmitted in response to the adjustment of at least one of the first actuator and the second actuator to coordinate the adjustment of the vehicle vision device with the sequential posture alignment. A vehicle vision device is in communication with the controller to receive the output signal indicative of adjustment of the vehicle vision device. The vehicle vision device comprises a display.

According to at least another embodiment, a vehicle assembly is provided with a seat assembly with a seat back. A first actuator is oriented in a first region of the seat back. A second actuator is oriented in a second region of the seat back. A controller is in electrical communication with the first and second actuators. The controller is programmed to operate the first actuator to adjust the first region of the seat back. The second actuator is operated to adjust the second region after initiating adjustment of the first actuator. An output signal indicative of adjustment of a vehicle vision device is transmitted in response to the adjustment of at least one of the first actuator and the second actuator to coordinate the adjustment of the vehicle vision device with the sequential posture alignment. A vehicle vision device is in communication with the controller to receive the output signal indicative of adjustment of the vehicle vision device. The vehicle vision device comprises a mirror assembly.

According to at least another embodiment, a seat assembly is provided with a seat back. A first actuator is oriented in a first region of the seat back. A second actuator is oriented in a second region of the seat back. A controller is in electrical communication with the first and second actuators. The controller is programmed to operate the first actuator to adjust the first region of the seat back. The second actuator is operated to adjust the second region after initiating adjustment of the first actuator. An output signal, indicative of adjustment of a vehicle drive control manual input device, is transmitted in response to the adjustment of at least one of the first actuator and the second actuator to coordinate the adjustment of the vehicle drive control manual input device with the sequential posture alignment.

According to at least another embodiment, a vehicle assembly is provided with a seat assembly with a seat back. A first actuator is oriented in a first region of the seat back. A second actuator is oriented in a second region of the seat back. A controller is in electrical communication with the first and second actuators. The controller is programmed to operate the first actuator to adjust the first region of the seat back. The second actuator is operated to adjust the second region after initiating adjustment of the first actuator. An output signal, indicative of adjustment of a vehicle drive control manual input device, is transmitted in response to the adjustment of at least one of the first actuator and the second actuator to coordinate the adjustment of the vehicle drive control manual input device with the sequential posture alignment. A vehicle drive control manual input device is in communication with the controller to receive the output signal indicative of adjustment of the vehicle drive control manual input device. The vehicle drive control manual input device comprises an adjustable foot pedal.

According to at least another embodiment, a vehicle assembly is provided with a seat assembly with a seat back. A first actuator is oriented in a first region of the seat back. A second actuator is oriented in a second region of the seat back. A controller is in electrical communication with the first and second actuators. The controller is programmed to operate the first actuator to adjust the first region of the seat back. The second actuator is operated to adjust the second region after initiating adjustment of the first actuator. An output signal, indicative of adjustment of a vehicle drive control manual input device, is transmitted in response to the adjustment of at least one of the first actuator and the second actuator to coordinate the adjustment of the vehicle drive control manual input device with the sequential posture alignment. A vehicle drive control manual input device is in communication with the controller to receive the output signal indicative of adjustment of the vehicle drive control manual input device. The vehicle drive control manual input device comprises an adjustable steering wheel assembly.

### BRIEF DESCRIPTION OF THE DRAWINGS

FIG. 1 is a front perspective view of a vehicle seat assembly, illustrated partially disassembled, according to an embodiment;

FIG. 2 is a display image for a vehicle seating system according to an embodiment;

FIG. 3 is another display image for the vehicle seating system of FIG. 2;

FIG. 4 is another display image for the vehicle seating system of FIG. 2;

FIG. 5 is another display image for the vehicle seating system of FIG. 2;

FIG. 6 is another display image for the vehicle seating system of FIG. 2;

FIG. 7 is another display image for the vehicle seating system of FIG. 2;

FIG. 8 is another display image for the vehicle seating system of FIG. 2;

FIG. 9 is another display image for the vehicle seating system of FIG. 2;

FIG. 10 is another display image for the vehicle seating system of FIG. 2;

FIG. 11 is a flowchart of a portion of an overall method for adjusting a vehicle seat assembly according to an embodiment;

FIG. 12 is a flowchart of another portion of an overall method for adjusting a vehicle seat assembly according to another embodiment;

FIG. 13 is a rear schematic view of a seat assembly and a skeletal occupant according to an embodiment;

FIG. 14 is a side schematic view of actuation zones and direction of a seat actuation system;

FIG. 15 is a series of side schematic views of an occupant in various postures; and

FIG. 16 is a system diagram of a vehicle assembly according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A comfort, posture and wellness seating system for vehicle seat assemblies, provides a visual interface with adjustment hardware organically or inorganically. The system may be employed to properly configure any new or existing seating system. The system can also address specific comfort, posture or preferences, such as thoracic support. The seating system objectifies comfort data and biomechanical knowledge to make the data transferable.

The comfort, posture and wellness seating system integrates anthropometry, bio-mechanics, and historical seating comfort data. The seating system can be employed in original equipment for vehicles or in aftermarket products. Applicable markets include automotive, mass transit, airlines, etc., as well as non-vehicular seating such as office, home, commercial, and public venue seating.

Data collection may be conducted that includes expert positioning of a suitable sample of occupants for optimal comfort or preferred posture by a medical professional. The data collection can be used at specific sites on an ongoing basis if required. The expert input provides a high level of expert comfort, posture and personalized fitting. The data may be based on anthropometry, body pressure distribution (BPD), status of actuators (such as pressure of inflatable air bladders, status of valves or the like), or other data that provides a comfort, posture and biomechanically optimized position of an adjustable vehicle seat assembly. The data is collected in a knowledge base or table for setting adjustments based on categories of data. The knowledge base may be compiled from the expert positioned data and the occupant specific data. The setting adjustments from the knowledge base are utilized for pre-set options in a vehicle seat assembly 28. The setting adjustments can be customized by a user at a controller or display.

Input data can be plotted versus adjustment settings for high level categorization. The settings can be categorized by topology clustering for setting the pre-set options. Various setting options may be provided for various types of driving. For example, a touring setting may provide per package settings and basic comfort, posture and wellness recommendations. The touring setting may also provide optimal visibility, use of features and controls, and the like. A performance setting may be provided for active drivers to provide a more erect position with firmer seating. Additionally, a luxury setting may be more reclined with softer seating.

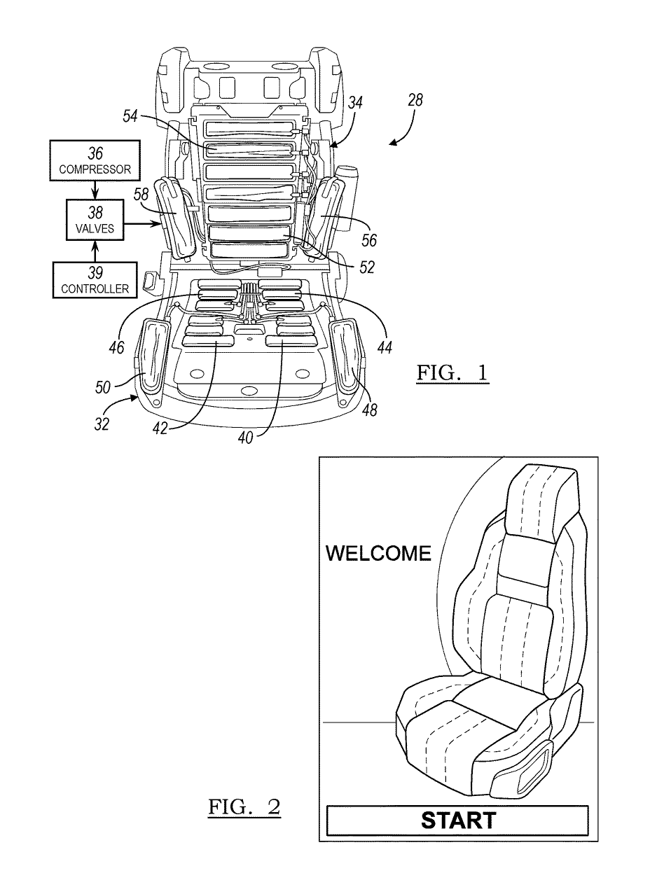

FIG. 1 illustrates the vehicle seat assembly 28 with a cover removed. The seat assembly 28 includes a seat cushion 32 adapted to be mounted for motor-driven adjustable translation in a fore and aft direction and in an up and down direction of a vehicle. The seat assembly 28 includes a seat back 34 pivotally connected to the seat cushion 32 to extend generally upright relative to the seat cushion 32 for motor-driven pivotal adjustment relative to the seat cushion 32. A head restraint (not shown) is mounted for motor-driven adjustable translation to the seat back 34.

At least one compressor 36 provides a source of air to the seat assembly 28. A plurality of valves 38 receive the compressed air and are controlled by a controller 39 for regulating compressed air into and out of the seat assembly 28. The seat cushion 32 includes a forward left air bladder 40, a forward right air bladder 42, a rear left air bladder 44, a rear right air bladder 46, a left side bolster air bladder 48, and a right side bolster air bladder 50. The seat back 34 includes a plurality of lumbar air bladders 52, a plurality of thoracic air bladders 54, a left side bolster air bladder 56, and a right side bolster air bladder 58. The valves 38 may be provided as a common valve bank that is housed in the seat back 34 or under the seat cushion 32; or the valves 38 may each be provided on each of the air bladders 40, 42, 44, 46, 48, 50, 52, 54, 56, 58. The compressor 36 may be provided in the seat back 34, the seat cushion 32 or concealed within the vehicle body. The controller 39 may be provided in a module under the seat cushion 32, and may be a multifunction controller that also controls other functions in the vehicle.

It is believed that supporting the thoracic region of the spine can reduce forces and support as much as one-third of the upper body mass. By increasing support of the upper body mass, loads are reduced on the muscles, ligaments, and spine and pelvic regions. Decreased load reduces fatigue on these areas of the body. The thoracic air bladders 54 are adjustable to provide the right degree of support in the correct location necessary to reduce such loading.

The controller 39 receives the adjustment settings from the pre-set data or from the customized data. The data may be input from an interface that is provided in the vehicle. The interface may be integrated into the vehicle, such as an instrument panel display that is in suitable wired or wireless communication with the controller 39. The interface may be remote, such as a personal digital assistant (PDA) including phones, tablets and the like. The interface may be provided as a smart device application, wherein users enter relevant information about themselves. The smart phone interface may not require on-site expertise or seat properties. The remote interface permits a user to transport settings to each vehicle, such as personal passenger vehicles, airline seating, rental cars, and the like.

Misalignments of spinal vertebrae and discs may cause irritation to the nervous system and may be an underlying cause to many health problems. Additionally, spinal misalignments can be a contributing factor to a herniated disc, a bulging disc, a facet joint problem, osteoarthritis and spinal stenosis. Sequential adjustment of a seat assembly can enhance posture to minimize spinal misalignments.

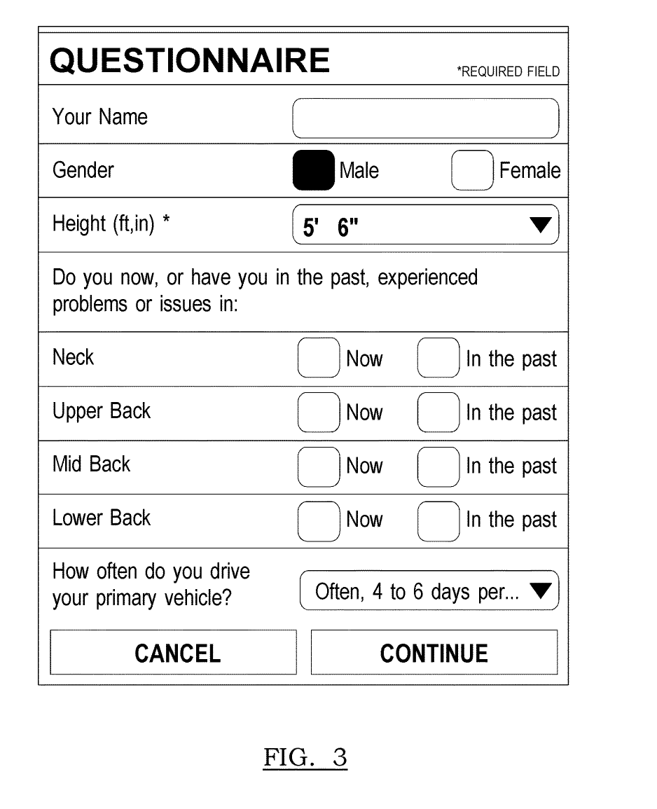

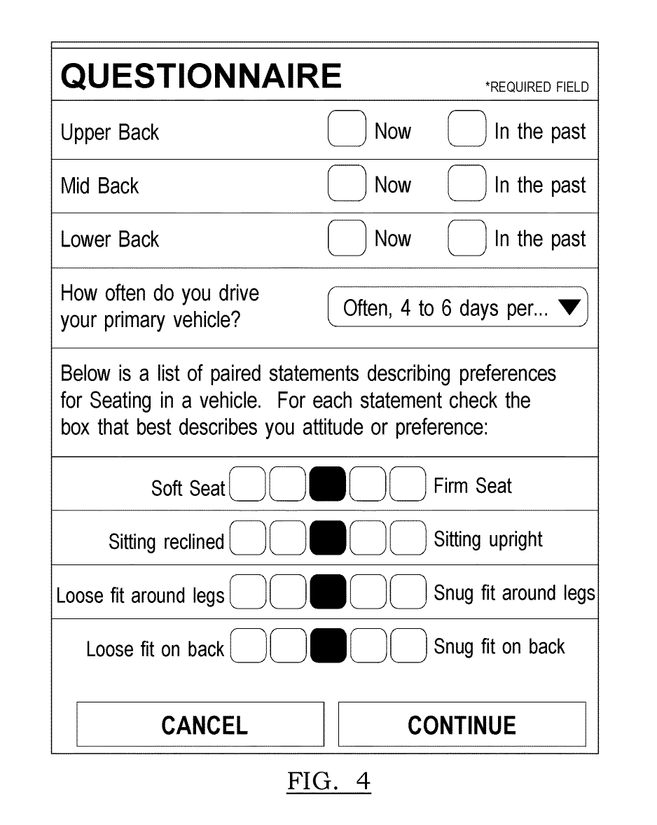

FIGS. 2-10 illustrate display images from an interface, such as a tablet. FIG. 2 illustrates a welcome screen wherein a data collection process is initiated. FIGS. 3 and 4 illustrate input screens wherein biometric, personal health and personal preference data, such as height and wellness, is collected. This data is utilized to adjust the seat to the pre-set options, based on the prior-collected data in the knowledge base or table.

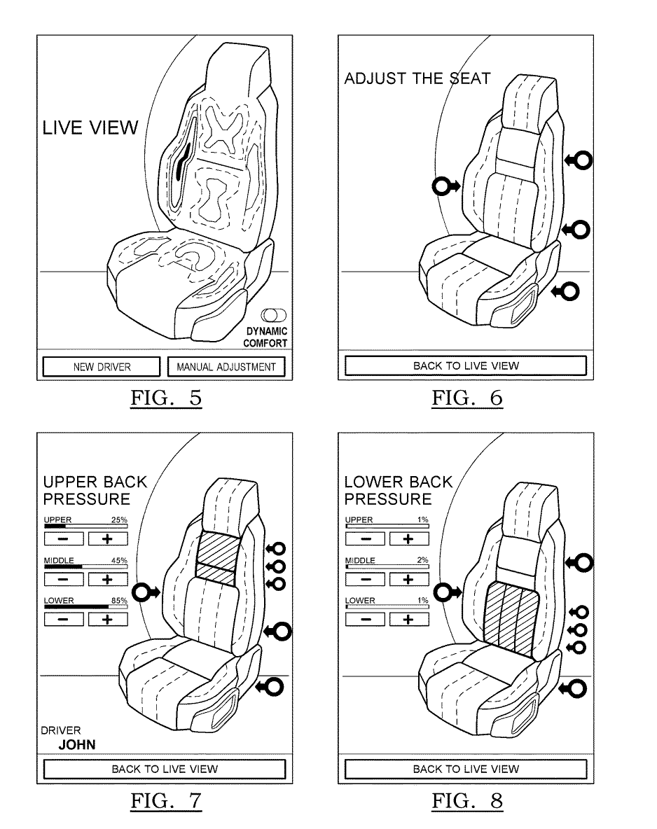

Each of the air bladders 40, 42, 44, 46, 48, 50, 52, 54, 56, 58 may include a pressure sensor to detect air pressure in the respective bladder 40, 42, 44, 46, 48, 50, 52, 54, 56, 58. Any pressure sensor is contemplated, such as a pneumatic pressure sensor at the outlet valve of each respective air bladder 40, 42, 44, 46, 48, 50, 52, 54, 56, 58. Pressure can also be sensed by contact pressure sensors disposed in front of or behind some or all of the respective air bladders, including on a front or rear surface thereof. The contact pressure sensors may include pressure-sensing mats, such as those available by Tekscan®, Inc. of 307 West First Street. South Boston, Mass. 02127-1309, USA. FIG. 5 illustrates a depiction of the vehicle seat assembly 28 with zones ranging in color to depict a distribution of pressure upon the seat assembly 28. This visualization may assist an occupant in positioning upon the seat assembly 28 with live visual feedback. If manual adjustment is selected, FIG. 6 requests the occupant to select a zone of the seat assembly 28 for adjustment. Once a zone is selected, such as thoracic in FIG. 7 or lumbar in FIG. 8, incremental adjustment of each air bladder 52 by the occupant is permitted.

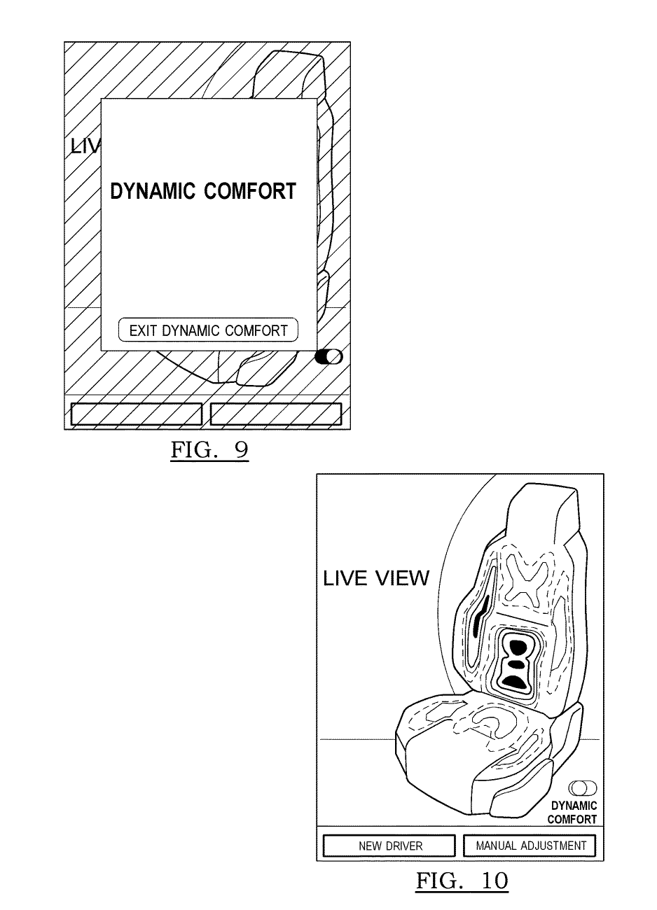

A dynamic comfort, posture and wellness option is offered. Selection of the dynamic comfort option measures the pressure in the sensors at FIG. 9, and displays a live view as in FIG. 10. The controller 39 compares the sensor values, and if the controller 39 determines that the occupant is not seated evenly, the controller 39 balances the air pressure in opposing air bladders to balance the occupant seating position.

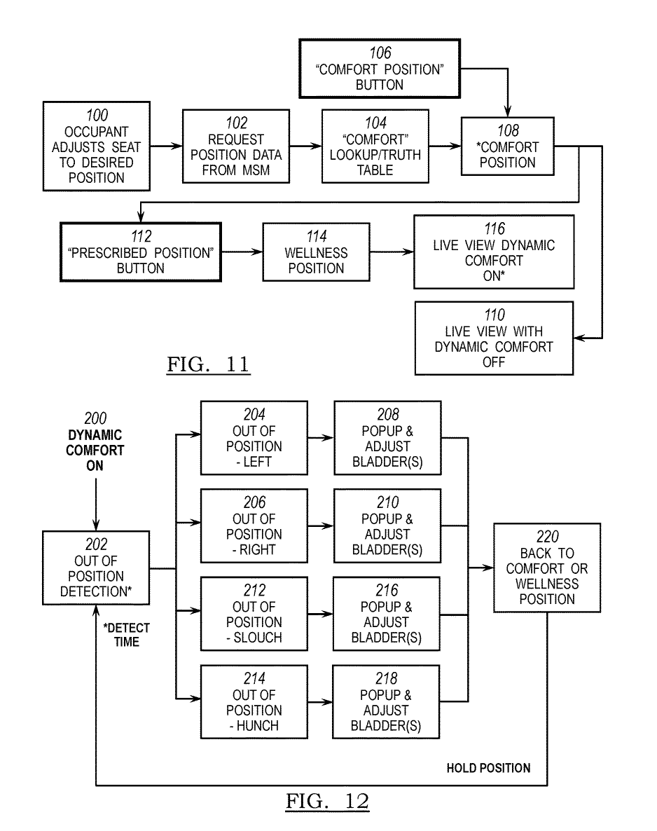

FIG. 11 depicts a flowchart for a method for adjusting the seat assembly 28 according to an embodiment. At block 100, the occupant adjusts the seat assembly 28 to a desired position. At block 102, position data is requested from a multicontour seat module to determine a manually adjusted position of the seat assembly 28. In block 104, the manually adjusted position is compared to a plurality of stored predetermined data ranges with corresponding preset seating positions to determine a preset seating position corresponding to the manually adjusted position, and to assign the associated preset seating position or “comfort position” to the manually adjusted position.

At block 108, the seat assembly 28 is adjusted to the comfort position or associated preset seating position. The comfort position is obtained in a comfort mode, as selected by a “comfort position” button at block 106. The “comfort position” button may be selected by default to obtain the comfort position. At block 110, a live view, such as FIG. 5 is generated and displayed.

According to an alternative embodiment, a collection of individuals were surveyed for comfort preferences and the data is tabulated into comfort seating positions for ranges of anthropometry data. The data received in the questionnaire in FIGS. 3 and 4 may be compared with the predetermined anthropometry data ranges, and the seat assembly 28 may be adjusted to a comfort position associated with the corresponding anthropometry data ranges.

Referring again to FIG. 11, upon occupant selection of a “prescribed position” button and block 112, a wellness mode of the seat assembly 28 is obtained. At block 114, the data received in the questionnaire of FIGS. 3 and 4 is compared with predetermined anthropometry data ranges. A table of predetermined wellness positions is prescribed by a health professional for optimal posture and wellness of various anthropometry ranges and stored in the controller. A prescribed wellness position is selected associated with the corresponding anthropometry data range for the data received by the occupant. At block 114, the seat assembly is adjusted to the wellness position. Then, at block 116, a live view, such as FIG. 10 is displayed. A dynamic comfort mode may be on at this stage, as selected at button 112.

FIG. 12 illustrates dynamic comfort adjustment of the seat assembly 28 according to an embodiment. At block 200 the dynamic comfort mode is selected, which may be comfort mode of block 106, or the wellness mode of block 112. A detect time, three seconds for example, takes measurements at the sensors or sensor mat at block 202. At blocks 204 and 206, the sensor values are compared to determine if the occupant is out of position from left to right relative to the comfort position or the prescribed position, depending upon the selected mode. If so, a popup is provided on the display at block 208 or 210 and the appropriate bladders are adjusted. For example, if the occupant is leaning too far to the left, the additional pressure is detected at block 204, then the message is displayed at block 208 and the left bladders are additionally inflated at block 208. During the left lean, if it is detected that a pressure decrease has occurred in the right bladders at block 206, the message will be displayed at block 210 and the right bladders may be deflated at block 210 to further adjust the left-leaning passenger back to a centered prescribed position. Likewise, these options can work in the opposite order for a passenger leaning to the right.

At blocks 212 and 214, the pressure of the bladders is compared to measure flexure and extension of the center bladders of thoracic, lumbar and sacrum regions. If it is determined that the occupant is slouching relative to the comfort or prescribed position at block 212, then a message indicating adjustment is provided in a popup of the display at block 216, and the appropriate bladders are at least partially inflated at block 216. If it is determined that the occupant is hunching relative to the prescribed position at block 214, then the message is provided at block 218 and the central bladders are at least partially deflated at block 218 to return the occupant to the prescribed wellness position.

At block 220, the occupant is returned back to the comfort position or the wellness position dependent upon the selected mode. To avoid continuous adjustment, a hold position such as five seconds occurs before repeating the sensor detection at block 202.

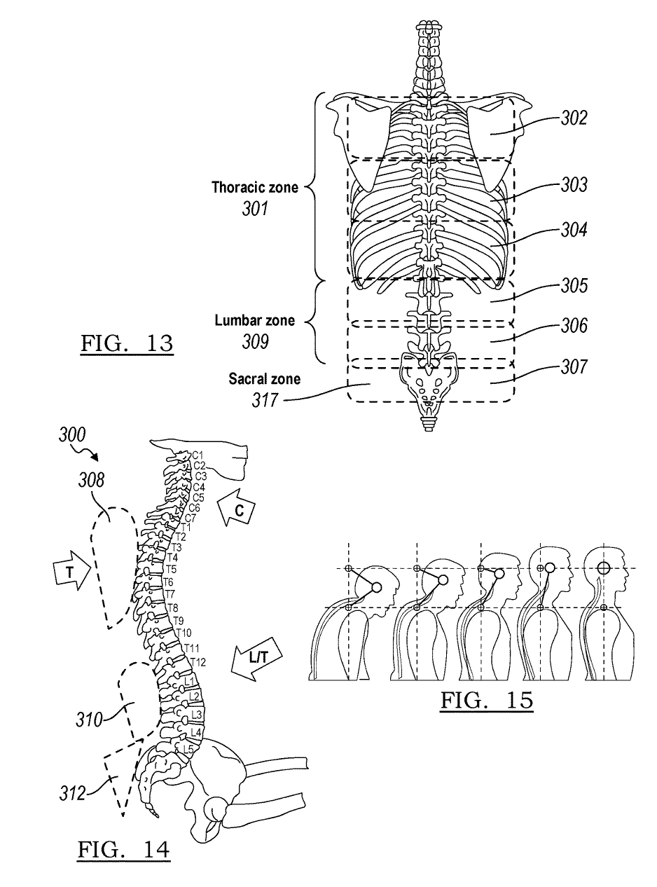

FIGS. 13 and 14 illustrate a seat assembly referenced by numeral 300. The seat assembly 300 is similar to prior embodiments, and is illustrated schematically without the frame, cushioning, trim, controller, valves, compressor and the like. The seat assembly 300 is also illustrated with a skeletal occupant for discussion of mechanical orientations of relevant biomechanical features of average occupants. The seat assembly 300 is depicted by an arrangement of air bladder assemblies, each named for a targeted position within the seat assembly 300 with reference to a corresponding contact region of an occupant. The air bladder assemblies include a thoracic air bladder assembly 301 located in a thoracic region of the seat assembly 300 to support a thoracic region of an occupant, which is the T1 to T12 vertebrae, the ribs and in between the scapulae or shoulder blades.

Referring to FIG. 13, a thoracic zone air bladder assembly 301 includes a scapular air bladder 302, a medial thoracic air bladder 303 below the scapular air bladder 302; and a low thoracic air bladder 304 is also provided beneath the medial thoracic air bladder 303, which extend to support spine, scapula, and ribs. The three thoracic air bladders 302, 303, 304 permit independent control of these regions for targeted support.

With continued reference to FIG. 13 a lumbar zone air bladder assembly 309 is provided below the thoracic air bladder assembly 301 to support the lower back at L1-L5 vertebrae. The lumbar zone air bladder assembly 309 includes a pair of air bladders 305, 306 according to an embodiment.

With continued reference to FIG. 13, a sacral zone air bladder assembly 317 is provided below the lumbar air bladder assembly 309 to support the sacral regions of the occupant. The sacral zone air bladder assembly 317 may be provided with a single air bladder 307.

According to at least one embodiment, the air bladders 302, 303, 304, 305, 306, 307 are inflated in a sequence to support posture alignment, posture support and movement. The sequence can be controlled by the seat controller 39 as described above in prior embodiments. Initially, the thoracic air bladder assembly 301 is inflated. The thoracic air bladders 302, 303, 304 may be inflated individually or simultaneously. FIG. 15 illustrates posture of an occupant during the inflation of the thoracic air bladders 303, 304 from left to right as the occupant approaches and achieves a wellness and posture position from back support 308 (FIG. 14) and forward motion (arrow T, FIG. 14) promoting pressure applied in thoracic T5-T10 vertebrae. With the improved posture, the occupant is induced to straighten his or her back and sit upright.

Subsequently, the lumbar air bladders 305, 306 are inflated thereby supporting the lumbar vertebrae with pressure 310 in FIG. 15, while the lower thorax and lumbar vertebrae move rearward (arrow L/T), and the cervical vertebrae (arrow C) move rearward. Next, the scapular air bladder 302 is inflated for scapular support. Subsequently, the sacral air bladder 307 is inflated for sacrum pressure 312 (FIG. 14) to promote a slight forward tilt.

Referring again to FIG. 13, the seat assembly 300 may include a plurality of sensors each in at least one of the air bladders 302, 303, 304, 305, 306, 307. The sensors measure pressure or proximity at each location to provide feedback to the controller 39 for subsequent adjustment and monitoring as described in the prior embodiments. The sensors may be bladder pressure sensors, bladder valve pressure feedback sensors, proximity sensors, tri-axial angular measurement sensors or the like. Additionally, any arrangement and quantity of sensors is contemplated for various seat assembly embodiments.

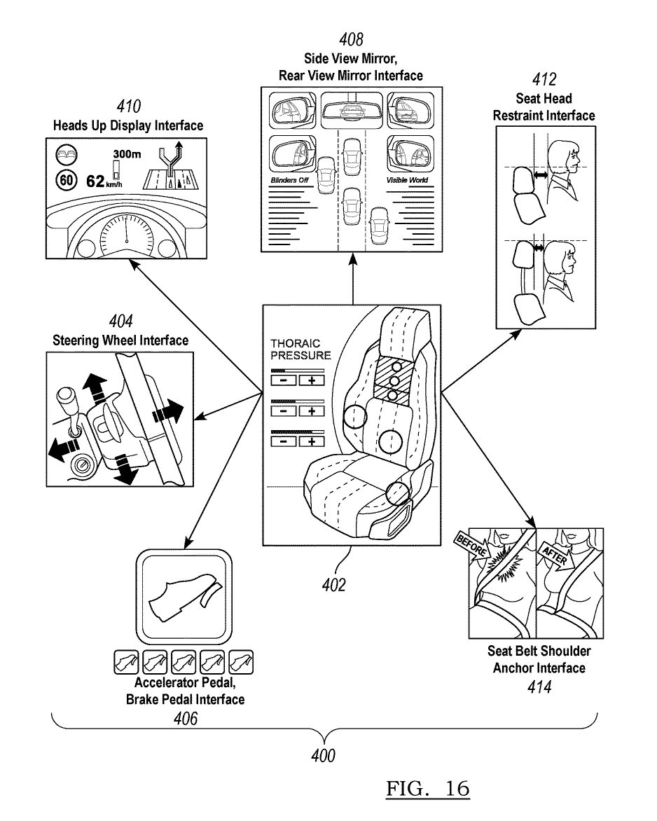

With reference now to FIG. 16, once the seat assembly 28, 300 and associated controls are activated to place an occupant in a proper seated posture, adjustments can be made to various power controlled interior components of a vehicle assembly to adapt to the seated postural change. All of these interior components interface with the occupant and can be affected by changes in occupant position. For illustration purposes, a display 402 is illustrated in FIG. 16. The display 402 communicates with the seat controller 39 as described above. A vehicle controller can communicate with the seat controller 39 via a computer network to the various interior components of the vehicle assembly 400 to adjust the various interior components via software to accommodate the occupant position. The occupant input and position information can then be used to adjust the interior features mentioned above. The adjustment of the seat assembly 28, 300 could be simultaneous, during or otherwise concurrent with the adjustments of the various interior components of the vehicle assembly 400. The adjustment of the various interior components of the vehicle assembly 400 may be in response to the adjustment of the seat assembly 28, 300. Alternatively, the seat assembly 28, 300 and the various interior components of the vehicle assembly 400 may be adjusted in a sequence.

According to one example, the controller 39 may communicate with a steering wheel interface 404. After the seat assembly 28, 300 is adjusted, a steering wheel assembly may be adjusted, such as tilt adjustment, extension/retraction adjustment, and/or raise/lower adjustment. The steering wheel adjustments may be prescribed by a health professional. Alternatively, the steering wheel adjustments may be determined based upon a detected occupant position. The steering wheel interface 404 may communicate with the controller 39 to report manual adjustments of the steering wheel to store the positions for a particular occupant.

The controller 39 may communicate with other vehicle drive control manual input devices, such as an accelerator pedal and brake pedal interface 406. After the seat assembly 28, 300 is adjusted, one or more of the foot pedals may be adjusted, such as an accelerator pedal and a brake pedal. The pedal adjustments may be prescribed, or determined based upon a detected occupant position. The pedal interface 406 may communicate with the controller 39 to report manual adjustments of the pedals to store the positions for a particular occupant.

Vehicle vision devices may also communicate with the controller 39, such as a side view mirror and rear view mirror interface 408. After the seat assembly 28, 300 is adjusted, one or more of the mirror assemblies may be adjusted, which include left and right side view mirrors and a rearview mirror. The mirror adjustments may be prescribed, or determined based upon a detected occupant position. The mirror interface 408 may communicate with the controller 39 to report manual adjustments of the mirrors to store the positions for a particular occupant.

The controller 39 may also communicate with a heads-up display interface 410. The heads-up display includes a projector for projecting information onto a portion of the windshield of the vehicle assembly 400. The adjustment may include orientation and focus prescribed for a particular user. After the seat assembly 28, 300 is adjusted, the display may be adjusted. The adjustments may be determined from a detected occupant position. The heads-up display interface 410 may communicate with the controller 39 to report manual adjustments of the display to store the adjustment data for a particular occupant.

Safety restraints may also communicate with the controller 39, such as a seat head restraint interface 412. After the seat assembly 28, 300 is adjusted, the head restraint may be extended forward and upward to minimize a gap between the head restraint and a head of an occupant. The head restraint adjustments may be prescribed, or determined from a detected occupant position. The seat head restraint interface 412 may communicate with the controller 39 to report manual adjustments of the head restraint to store the positions for a particular occupant. Alternatively, the seat head restraint interface 412 may be incorporated into the controller 39.

A seat belt shoulder anchor interface 414 is also depicted in communication with the seat assembly controller 39. The seat belt shoulder anchor may be affixed to a vehicle body pillar, or the seat assembly 28, 300. After the seat assembly 28, 300 is adjusted, the seat belt shoulder anchor may be translated to an optimal comfort, wellness or safety position. The seat belt shoulder anchor adjustments may be prescribed, or determined from a detected occupant position. The seat belt shoulder anchor interface 414 may communicate with the controller 39 to report manual adjustments of the seat belt shoulder anchor to store the positions for a particular occupant. Alternatively, the seat belt shoulder anchor interface 414 may be incorporated into the controller 39.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A seat assembly comprising:
a seat back;
a first actuator oriented in a first region of the seat back;
a second actuator oriented in a second region of the seat back;
a safety restraint connected to the seat back;
a third actuator connected to the safety restraint; and
a controller in electrical communication with the first and second actuators, the controller programmed to:
operate the first actuator to adjust the first region of the seat back,
operate the second actuator to adjust the second region after initiating adjustment of the first actuator, and
operate the third actuator to adjust the safety restraint in response to the adjustment of at least one of the first actuator and the second actuator to coordinate the adjustment of the safety restraint with the sequential posture alignment.

2. The seat assembly of claim 1 wherein the safety restraint comprises a head restraint.

3. The seat assembly of claim 2 wherein the third actuator adjusts the head restraint by moving the head restraint forward and upward toward a predetermined occupant seating position.

4. The seat assembly of claim 1 wherein the safety restraint comprises a seat belt restraint.

5. The seat assembly of claim 4 wherein the third actuator adjusts a shoulder anchor interface of the seat belt restraint.

6. The seat assembly of claim 1 wherein first region is further defined as a thoracic region.

7. The seat assembly of claim 6 wherein the second region is further defined as at least one of a lumbar region, a sacrum region, and a scapular region of the seat back.

8. A seat assembly comprising:
a seat back;
a first actuator oriented in a first region of the seat back;
a second actuator oriented in a second region of the seat back; and
a controller in electrical communication with the first and second actuators, the controller programmed to:
operate the first actuator to adjust the first region of the seat back,
operate the second actuator to adjust the second region after initiating adjustment of the first actuator, and
transmit an output signal indicative of adjustment of a vehicle vision device in response to the adjustment of at least one of the first actuator and the second actuator to coordinate the adjustment of the vehicle vision device with the sequential posture alignment.

9. A vehicle assembly comprising:
a seat assembly according to claim 8; and
a vehicle vision device in communication with the controller to receive the output signal indicative of adjustment of the vehicle vision device, and wherein the vehicle vision device comprises a display.

10. The vehicle assembly of claim 9 further comprising a windshield; and
wherein the display comprises a projected image upon the windshield.

11. A vehicle assembly comprising:
a seat assembly according to claim 8; and
a vehicle vision device in communication with the controller to receive the output signal indicative of adjustment of the vehicle vision device, and wherein the vehicle vision device comprises a mirror assembly.

12. The vehicle assembly of claim 11 wherein the mirror assembly comprises a side view mirror assembly.

13. The vehicle assembly of claim 11 wherein the mirror assembly comprises a rearview mirror assembly.

14. A seat assembly comprising:
a seat back;
a first actuator oriented in a first region of the seat back;
a second actuator oriented in a second region of the seat back; and
a controller in electrical communication with the first and second actuators, the controller programmed to:
operate the first actuator to adjust the first region of the seat back,
operate the second actuator to adjust the second region after initiating adjustment of the first actuator, and
transmit an output signal indicative of adjustment of a vehicle drive control manual input device in response to the adjustment of at least one of the first actuator and the second actuator to coordinate the adjustment of the vehicle drive control manual input device with the sequential posture alignment.

15. A vehicle assembly comprising:
a seat assembly according to claim 14; and
a vehicle drive control manual input device in communication with the controller to receive the output signal indicative of adjustment of the vehicle drive control manual input device, and wherein the vehicle drive control manual input device comprises an adjustable foot pedal.

16. The vehicle assembly of claim 15 wherein the adjustable foot pedal further comprises an adjustable accelerator foot pedal.

17. The vehicle assembly of claim 15 wherein the adjustable foot pedal further comprises an adjustable brake foot pedal.

18. A vehicle assembly comprising:
a seat assembly according to claim 14; and
a vehicle drive control manual input device in communication with the controller to receive the output signal indicative of adjustment of the vehicle drive control manual input device, and wherein the vehicle drive control manual input device comprises an adjustable steering wheel assembly.

19. The vehicle assembly of claim 18 wherein the adjustable steering wheel assembly is extendable.

20. The vehicle assembly of claim 18 wherein the adjustable steering wheel assembly is tiltable.
